(19) United States
(12) Patent Application Publication
(10) Pub. No.: US 2024/0035513 A1
(43) Pub. Date: Feb. 1, 2024

(54) UNION WITH INTEGRATED NEEDLE ROLLER BEARINGS

(71) Applicant: Deublin Company, LLC, Waukegan, IL (US)

(72) Inventors: Anton A. Petrou, Hawthorn Woods, IL (US); Matthew James Clifford, Vernon Hills, IL (US)

(21) Appl. No.: 18/226,462

(22) Filed: Jul. 26, 2023

Related U.S. Application Data
(60) Provisional application No. 63/369,751, filed on Jul. 28, 2022.

(51) Int. Cl. F16C 19/48; F16C 33/66; F03D 80/70

(52) U.S. Cl. CPC F16C 19/48; F16C 33/6659; F03D 80/703; F03D 80/709; F16C 2360/31; F05B 2240/50; F05B 2260/98

(57) ABSTRACT

A union having a rotor shaft having first and second portions, wherein two channels are formed in the second portion of the shaft, and a housing that includes a central bore that extends between the two channels. Two needle roller bearings are disposed, one each, within each of the two channels to rotatably support the rotor shaft within the housing.

### CROSS REFERENCE TO RELATED APPLICATIONS

The instant application claims the benefit of Provisional U.S. Patent Application Ser. No. 63/369,751, filed Jul. 28, 2022, which is incorporated herein in its entirety by reference.

### BACKGROUND OF THE INVENTION

Unions having a rotor and a rotor housing can be used in wind turbine applications to facilitate the transfer of pressurized media, such as oil, from a stationary supply to rotating machinery. Such uses can include, for example, the supply of pressurized oil to control blade pitch on a vane or blade that is connected to the rotor hub of a wind turbine. When used in this way, the rotor of the union itself typically rotates at the same speed as the rotor hub of the wind turbine, while the union housing remains stationary.

Such unions conventionally utilize a hydrodynamic bushing or bearing supported rotor, which at high rotational speeds rides on an oil film located between the rotor and an adjacent surface of the housing. Leakage is typically kept to a minimum by employing a small seal gap between the rotor and the housing. Such an arrangement requires close tolerances, and often closely ground bushings that are heat-shrunk into the housing, or, alternatively, precisely dimensioned ball bearings are used to support the rotor. Such close tolerances can often require multiple grinding operations to ensure a close fit and a small gap between the rotor and the housing, thus effectively pairing a specific rotor to fit within the interior of a specific housing having complementary dimensions.

### BRIEF SUMMARY OF THE DISCLOSURE

The present disclosure describes a wind turbine rotary union shaft bearing arrangement that includes a union, which eliminates the need for high precision ball bearings or closely ground bushings, through the use of a full complement of needle rollers riding in a pair of grooves located on the outer surface of the rotor. The needle roller bearings surround the rotor and ride directly on an interior surface of the housing bore, which acts as both the outer race of the integrated roller bearings and the outer side of the seal gap, resulting in low contact stresses between the interior of the housing and the needle roller bearings. This arrangement yields long life without the need for hardening the inner housing bore, thus eliminating the need for precision grinding after heat treating. The number of dimensional tolerances that must be met to manufacture and assemble the individual components of the union is therefore reduced, permitting the seal gap to be optimized for manufacturability using simple grinding operations, which is an improvement over known union configurations. A union in accordance with the disclosure extends service life and improves durability as compared to previous designs. The present disclosure further describes a union that includes controlled leakage channels to minimize and inhibit leakage to the environment.

### BRIEF DESCRIPTION OF THE SEVERAL VIEWS OF THE DRAWING(S)

FIG. 1 is a perspective view of a union in accordance with the disclosure.

FIG. 2 is an outline view of an end of a union in accordance with the disclosure.

FIG. 3 is a cross-section of the union shown in FIG. 2 taken along section line 3-3.

FIG. 4 is a cross-section of the union shown in FIG. 2 taken along section line 4-4.

FIG. 5 is a cross-section of the union shown in FIG. 2 taken along section line 5-5.

### DETAILED DESCRIPTION OF THE DRAWINGS

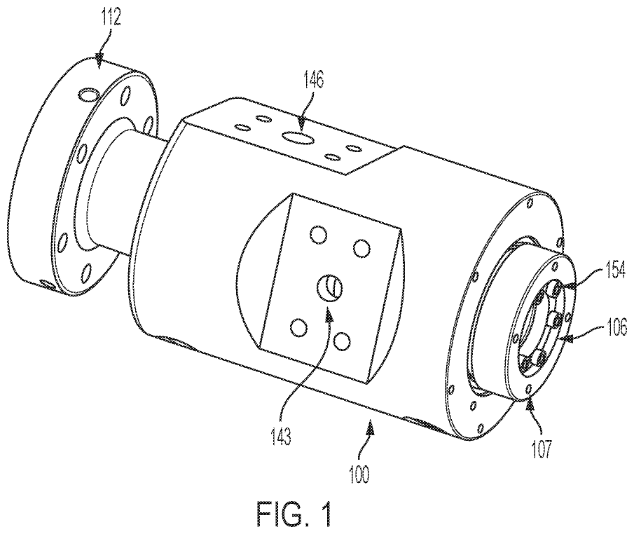

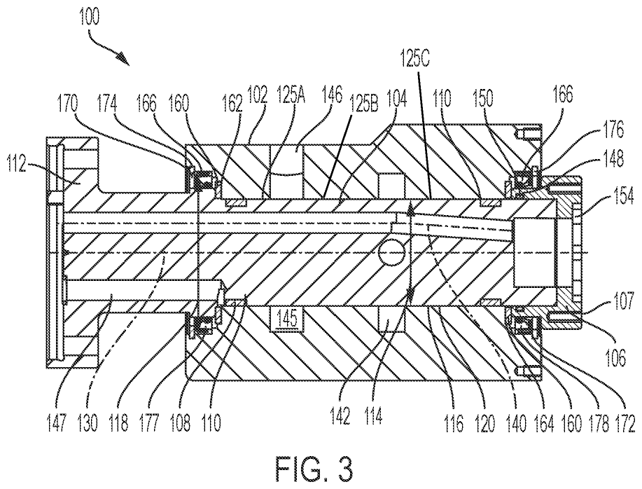

A perspective view of a wind turbine rotary union shaft bearing arrangement that includes a union 100 in accordance with the present disclosure is shown in FIG. 1, and a section view thereof is shown in FIGS. 3, 4 and 5. In reference to these figures, the union 100 in this illustrated embodiment includes a housing 102 that partially surrounds a rotor shaft 104, as seen in the cross-sectional views of FIGS. 3, 4 and 5. At one end, the rotor shaft 104 is connected to an end cap 106 that provides an interface for a connection to, for example, an encoder (not shown) which may be connected to the end cap 106 by bolts threaded into tapped holes 107. A flange 112 is associated with the rotor shaft 104 at a second end thereof and can be connected, for example, to the shaft of a transmission in a wind turbine.

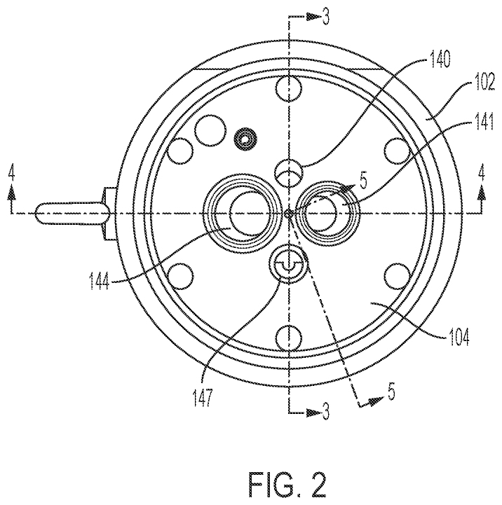

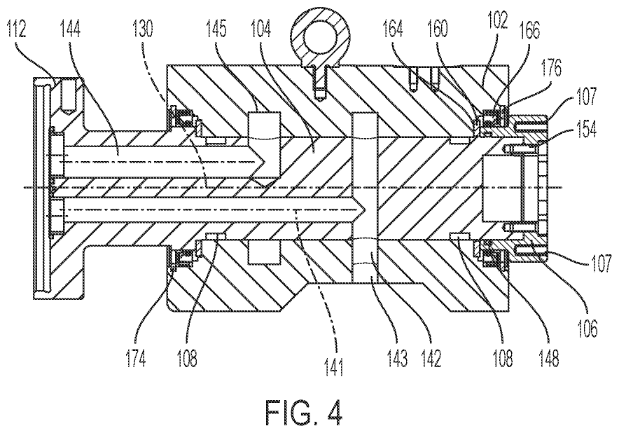

FIG. 2 is an end view of the rotor shaft 104 and flange 112, and shows cross-section lines 3-3, 4-4 and 5-5 along which cross-sectional views of the union of FIG. 1 are shown, respectively, in FIGS. 3-5. As best shown in FIG. 3, the housing 102 incudes a central bore 114 extending through the housing 102 along a centerline 130. In the illustrated embodiment, the central bore 114 is generally cylindrical and defines a minor inner diameter 116 and a major inner diameter 118 which is dimensioned to accommodate seals between the rotor shaft 104 and the housing 102 to fluidly isolate hydraulic fluid and control leakage, as will be explained further below with respect to FIG. 4.

Also shown in FIG. 3, a bore 140 extends through the rotor shaft and can serve as a dry raceway for wires running through the union 100 from the flange 112 to the end cap 106, which wires can be connected to an encoder or other device requiring an electrical connection. It should be appreciated, however, that a media channel could extend axially through the rotor shaft 104 to provide media, such as hydraulic fluid to a rotating component attached to end cap 106.

In the illustrated embodiment, the rotor shaft 104 is generally cylindrical and a small seal gap, denoted generally by reference numeral 125, and which may include segments A-C as shown in FIG. 3, is formed between the surface of the rotor shaft 104 and the surface 120 defined by the minor inner diameter 116 of the housing bore 114 when the rotor shaft is located within the housing 102. Hydraulic fluid acting as a lubricant can be supplied at high pressure to the seal gaps 125A, 125B and 125C via channels 141, 142 formed in the rotor shaft and housing, respectively, as shown in FIGS. 3 and 4. As shown in FIG. 4, an inlet 143 for hydraulic fluid at high pressure can be connected via a connection (not shown) to a hydraulic pump so that hydraulic fluid can be supplied to the actuator to control, for example, the pitch of a blade connected to the rotor hub of a wind turbine. The hydraulic fluid can be drained from the actuator and the union 100 through drains comprising channels 144, 145 formed in the rotor shaft 104 and the housing 102, respectively. The channel 145 in the housing 102 can have an outlet 146 that connects via a connector (not shown) to a hydraulic fluid return line from the actuator.

The three seal gaps 125A-C between the rotor shaft 104 and the housing 102 may be maintained by a full complement of needle rollers 108. As used herein, a full complement needle roller bearing is a bearing that is not equipped with a cage and includes a maximum number of needle rollers. Although a full complement, single row, needle roller bearing is shown in the illustrated embodiments, it is contemplated that needle rollers with cages can also be used. In the illustrated embodiment, the needle roller bearings 108 ride in circumferential grooves 110 located in the surface of the rotor shaft 104 and are spaced apart along the center line 130. The needle roller bearings 108 surround the rotor and ride directly against the inner surface 120 of the housing 102. The housing bore thus acts as the outer raceway of the needle roller bearings and the outer edge of the gap formed between the surface 120 of the housing bore and adjacent surface of the rotor shaft 104. The needle roller bearings 108 stabilize and align the rotor shaft 104 within the housing bore 114 and provide a seal gap, denoted generally by reference numeral 125, for pressurized hydraulic fluid. Preferably the seal gap is dimensioned to be small so that the amount of hydraulic fluid flowing between the housing 102 and the rotor shaft 104 is minimal, to keep potential leakage to a minimum. Moreover, the gap is sized to provide fluid to the gap and minimize leakage from the supply channels 141, 142, to the drain channels 144, 145, and to a drain 147, of high-pressure fluid through the seal gaps 125A-C. The seal gaps 125A-C must also be sized to prevent contact between the rotor and the housing bore. The minimum seal gap must be sufficient to prevent contact due to tolerance stack-ups as well as pressure and load induced deflections. As shown in FIG. 3, the drain 147 shown as an axial bore in the rotor shaft 104 can drain hydraulic fluid from the seal gap 125.

As shown in FIG. 4, the end cap 106 is secured to the rotor shaft 104 by threaded cap screws 154 (FIG. 1, two shown in FIG. 4), thus rigidly connecting the end cap 106 to the rotor shaft 104. It is contemplated that any number of fasteners or any other fastening arrangement can be used. A static seal 148, such as an O-ring, is disposed within a circumferential groove 150 in the end cap 106 and fluidly isolates the lubricant in the seal gap between the housing bore 114 and the rotor shaft 104 from flowing into the dry wire channel 140. Thrust washers 160 can be used to bear against radial surfaces 162, 164 at opposing ends of the housing 102, and lip seals 166 can be located within stepped bores 170, 172 and held in place by retaining rings 174, 176 to define annular collection cavities 177, 178 at each end of the housing 102. The thrust washers 160 are in opposed relation. The collection cavities 177, 178 can collect hydraulic fluid that has not been drained from the seal gap via drain channel 147, and can inhibit hydraulic fluid, which has passed through the gap acting as a small opening that reduces the pressure of the hydraulic fluid to a low pressure, from leaking from the housing to the environment. It is contemplated that other seals or arrangements can be used to form and define such collection cavities.

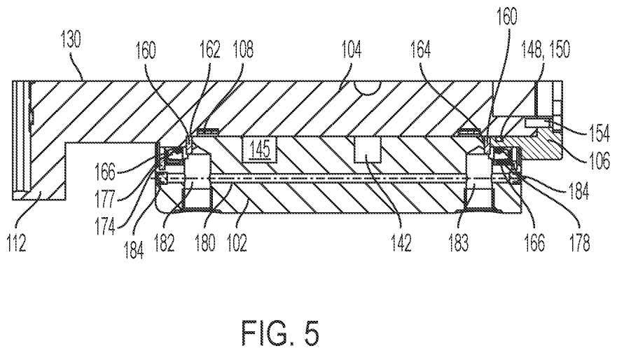

FIG. 5 shows a sectional view of the housing along a radius 5-5 as shown in FIG. 2. As illustrated in FIG. 5, a cross-channel 180 is spaced from the centerline 130 of the housing and extends from one end of the housing 102 to the other and fluidly connects two radial channels 182, 183 formed in the housing 102. Those radial channels 182, 183 are each fluidly connected to a collection cavity 177, 178 and can drain fluid that collects in those cavities from the union 100. It will be appreciated that because the radial channels 182, 183 are connected by cross-channel 180, only one of radial channels 182, 183 needs to be connected to a drain line (not shown) to drain hydraulic fluid from the collection cavities. The other radial channel can be plugged. As shown in FIG. 5, the ends of the cross-channel 180 may be sealed with plugs 184 to prevent uncontrolled external leakage.

Conventional roller bearings typically require inner and outer races that can require a press-fit to be assembled with other components, such as a rotor and a rotor housing. Press-fits can introduce complexity to the assembly and disassembly of a device. The illustrated embodiment of the disclosure provides a structure that is easy to assemble and disassemble without the use of such press-fits. The illustrated embodiment can be assembled by placing the needle roller bearings 108 in the two circumferential grooves 110 located in the surface of the rotor shaft 104 (as best shown in FIG. 5), locating thrust washers 160 against radial surfaces 162, 164 of the housing, then installing lip seals 166 and retaining rings 174, 176. The rotor shaft 104 can then be inserted into the housing bore 102, and the endcap 106 can be secured to the end of the rotor shaft 104 by fasteners such as cap screws 154. When used in a wind turbine, it is contemplated that the rotor shaft 104 will typically rotate between ten to thirty revolutions per minute, and that the internal temperature of the hydrostatic union at the surface 120 can be up to 158° F. (70° C.). Hydraulic fluid flowing through channel 146 to a hydraulic actuator can be pressurized to 4,000 PSI. At these operating conditions, the hydrostatic union of the disclosure may be expected to have a minimum service life of 20 years.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A wind turbine rotating union shaft bearing arrangement, comprising:
a union, the union including a rotor shaft extending between first and second ends, the first end including a flange, the rotor shaft having a stepped diameter that includes a major diameter extending along a first portion of the shaft adjacent the first end, and a minor diameter extending along a second portion of the shaft between the first portion and the second end, wherein two channels are formed in the second portion of the shaft;
a housing that includes a central bore disposed between two thrust cavities, the central bore at least partially surrounding at least a portion of the rotor shaft, wherein the central bore extends at least between the two channels;
an end cap disposed at the second end of the rotor shaft;
two needle roller bearings disposed, one each, within each of the two channels, the two needle roller bearings rotatably supporting the rotor shaft within the housing;
a dry channel extending through the rotor shaft between the first and second ends;
a fluid supply conduit extending at least partially through the rotor shaft; and
a fluid return conduit extending at least partially through the rotor shaft;
wherein a radial gap is defined between an outer surface of the second portion of the rotor shaft and the inner surface of the central bore, the radial gap being fluidly connected to the fluid supply and adapted to receive high pressure fluid provided through the fluid supply conduit to form a hydrodynamic seal between the rotor shaft and the housing.

2. The wind turbine union shaft bearing arrangement of claim 1, wherein one of the two channels disposed adjacent the first portion, and another of the two channels disposed adjacent the second end.

3. The wind turbine union shaft bearing arrangement of claim 1, wherein each of the two needle roller bearings having a carrier associated with rollers, the rollers contained with a respective one of the two channels and an inner surface of the central bore.

4. The wind turbine union shaft bearing arrangement of claim 1, further comprising two thrust washers disposed, one each, within each of the two thrust cavities.

5. The wind turbine union shaft bearing arrangement of claim 4, further comprising two sliding seal packages disposed one each, within each of the two thrust cavities externally relative to the two thrust washers.

6. The wind turbine union shaft bearing arrangement of claim 5, wherein the radial gap is further defined between the two sliding seal packages.

7. The wind turbine union shaft bearing arrangement of claim 4, wherein the two thrust washers are faced in opposed directions.

8. The wind turbine union of claim 7, wherein the thrust washers bear against a respective radial surface at opposing ends of the housing.

9. The wind turbine union shaft bearing arrangement of claim 8, further comprising lip seals located within stepped bores and held in place by retaining rings to define annular collection cavities at each end of the housing, wherein the collection cavities are adapted to collect hydraulic fluid that has not been drained from the seal gap via the drain channel.

10. The wind turbine union shaft bearing arrangement of claim 1, wherein at least one of the two needle roller bearings is a full complement needle roller bearing.

11. A method for supporting a wind turbine union shaft, comprising:
providing a union, the union including a rotor shaft extending between first and second ends, the first end including a flange, the rotor shaft having a stepped diameter that includes a major diameter extending along a first portion of the shaft adjacent the first end, and a minor diameter extending along a second portion of the shaft between the first portion and the second end, wherein two channels are formed in the second portion of the shaft;
providing a housing that includes a central bore disposed between two thrust cavities, the central bore at least partially surrounding at least a portion of the rotor shaft, wherein the central bore extends at least between the two channels;
providing an end cap disposed at the second end of the rotor shaft;
providing two needle roller bearings disposed, one each, within each of the two channels, the two needle roller bearings rotatably supporting the rotor shaft within the housing;
defining a dry channel extending through the rotor shaft between the first and second ends;
defining a fluid supply conduit extending at least partially through the rotor shaft; and
defining a fluid return conduit extending at least partially through the rotor shaft;
wherein a radial gap defined between an outer surface of the second portion of the rotor shaft and the inner surface of the central bore is fluidly connected to the fluid supply and receives high pressure fluid provided through the fluid supply conduit to form a hydrodynamic seal between the rotor shaft and the housing during operation.

12. The method of claim 11, wherein one of the two channels disposed adjacent the first portion, and another of the two channels disposed adjacent the second end.

13. The method of claim 11, wherein each of the two needle roller bearings having a carrier associated with rollers, the rollers contained with a respective one of the two channels and an inner surface of the central bore.

14. The method of claim 11, further comprising two thrust washers disposed, one each, within each of the two thrust cavities.

15. The method of claim 14, further comprising two sliding seal packages disposed one each, within each of the two thrust cavities externally relative to the two thrust washers.

16. The method of claim 15, wherein the radial gap is further defined between the two sliding seal packages.

17. The method of claim 14, wherein the two thrust washers are faced in opposed directions.

18. The method of claim 17, wherein the thrust washers bear against a respective radial surface at opposing ends of the housing.

19. The method of claim 18, further comprising lip seals located within stepped bores and held in place by retaining rings to define annular collection cavities at each end of the housing, wherein the collection cavities are adapted to collect hydraulic fluid that has not been drained from the seal gap via the drain channel.
